(19) United States
(12) Patent Application Publication
(10) Pub. No.: US 2005/0018758 A1
(43) Pub. Date: Jan. 27, 2005

(54) Receiving spread spectrum signal in radio system

(76) Inventors: Yrjo Keranen, Oitti (FI); Timo Viero, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/917,434

(22) Filed: Aug. 13, 2004

Related U.S. Application Data
(63) Continuation of application No. PCT/FI02/00164, filed on Mar. 4, 2002.

(51) Int. Cl. H04B 1/707

(52) U.S. Cl. 375/148; 375/150

(57) ABSTRACT

The invention relates to a rake receiver in a radio system comprising means for receiving a spread spectrum signal in a radio system, a correlator for forming an impulse response that represents, on the time domain, delay components of a user signal contained in the spread spectrum signal. The rake receiver comprises means for measuring, from the formed impulse response, a delay spread of delay components that are significant for reception of the user signal, and means for determining the length of a measuring window of one or more correlators by means of the measured delay spread of the user signal.

### FIELD

The invention is applied to radio systems realized by the spread spectrum technique. The invention relates particularly to a rake receiver used in such a radio system.

### BACKGROUND

In radio systems, such as mobile systems, a radio signal between a mobile station and a base station propagates along several paths between a transmitter and a receiver. The signal can propagate directly from the mobile station to the base station if no obstacles occur between them. In urban environments, buildings, vehicles and other obstacles subject a radio signal to reflection and scattering. The multipath-propagated signal components may travel different distances over the radio path, resulting in different arrival times of the components at the receiver. Some radio systems, such as systems realized by the spread spectrum technique and applying code division multiple access (CDMA), are able to utilize the multipath propagation of radio signals. A receiver thus receives several multipath-propagated signal components, which are amplified and combined in order to better identify the signal that was originally transmitted.

In CDMA, user signals are distinguished from one another by means of channelization and scrambling codes allocated individually to users, the codes modulating the baseband and thus spreading the data signal band. A combination of channelization and scrambling codes will be referred to hereinafter as a spreading code. Correlators provided in receivers synchronize with a desired signal, identified by means of the spreading code, and they restore the signal band to the original width. Signals arriving at the receiver and containing some other spreading code do not ideally correlate but retain their wide band and are thus visible as noise in the receiver. The channelization codes used in the system are preferably selected so as to be mutually orthogonal, i.e. they do not correlate with one another. One user may utilize one or more channelization codes, depending on the amount of transmission capacity needed.

A receiver generally used in a CDMA system is a rake receiver consisting of one or more rake fingers, i.e. correlators. The rake fingers are independent receiver units, the function of each unit being to compose and demodulate one multipath-propagated received signal component. The signals received by different rake fingers are combined in a receiver to provide a more reliable signal. In addition to rake fingers intended for receiving signals, a receiver typically comprises at least one separate searcher, the function of which is to form an impulse response for a user signal, representing different user signal components by means of a delay and a amplitude. A searcher typically employs a correlator, i.e. a matched filter (MF). A matched filter calculates one or more points of a user channel impulse response at a time. An actual measuring window, which covers the duration of forming an impulse response, is typically for example 64 chips in length. A matched filter requires 64 separate measurements for calculating an impulse response if the filter correlates only one code phase at a time, whereas a matched filter of e.g. 16 chips requires four consecutive measurements. Significant signal components located from the impulse response are allocated to the fingers of the rake receiver for monitoring the delay component in time.

A measuring window used in a known manner in the reception of a spread spectrum signal is oversized in several occasions, which has resulted in unnecessarily vast use of expensive equipment resources in the receivers, such as matched filters and software designed to control the filters.

### BRIEF DESCRIPTION

An objective of the invention is thus to provide an improved arrangement for allocating equipment resources in receivers realized by the spread spectrum technique. This is achieved by a method according to the invention of receiving a spread spectrum signal in a radio system receiver, the method comprising the steps of receiving a spread spectrum signal comprising one or more user signals in a receiver, forming an impulse response representing delay components of a user signal on the time domain. The method comprises measuring, from the formed impulse response, a delay spread of the delay components that are significant for the reception of the user signal, and determining, in the receiver, lengths of measuring windows for impulse responses related to one or more user signals by means of the measured delay spread.

The invention also relates to a method of preliminary synchronization of a user signal contained in a spread spectrum signal in a radio system receiver, the method comprising the steps of receiving a spread spectrum signal comprising one or more user signals in the receiver, searching the user signal on the delay domain for a first delay component. The method comprises searching for delay components of the user signal from both sides of the first located delay component on the delay domain, so that the user signal is searched from both sides of the located signal component for a period of time equal to a maximum delay spread of the impulse response in the operating range of the receiver.

The invention also relates to a rake receiver comprising means for receiving a spread spectrum signal in a radio system, means for forming an impulse response representing, on the time domain, delay components of a user signal contained in the spread spectrum signal. The rake receiver comprises means for measuring, from the formed impulse response, a delay spread of delay components that are significant for the reception of the user signal, means for determining the length of the measuring window for the impulse response by means of the measured delay spread of the user signal.

The invention further relates to a rake receiver comprising means for receiving a spread spectrum signal containing one or more user signals, means for locating the first delay component from the user signal. The locating means are configured to search for other delay components of the user signal from both sides of the first located delay components on the delay domain by searching the user signal from both sides for a period of time equal to a maximum delay spread of the impulse response of the user signal in the operating range of the receiver.

The invention thus relates to an arrangement for optimum allocation of equipment resources in radio systems realized by the spread spectrum technique. The present invention relates to receivers implemented in such a radio system. However, the invention is not restricted to CDMA methods only, but the multiple access method can also be time division multiple access (TDMA) or frequency division multiple access (FDMA) combined with the CDMA. An example of a radio system according to the invention is thus the 3G universal mobile telecommunications system (UMTS), which is realized by means of wideband CDMA (WCDMA).

The invention is preferably implemented in a rake-type receiver comprising one or more searchers, or delay estimators, and one or more fingers. The invention relates particularly to the operation of a searcher, which is intended to form an impulse response for a user signal by searching for delays and amplitudes of multipath-propagated signal components. The located signal components are allocated to the fingers of the rake receiver, each finger monitoring a phase of a spreading code allocated thereto. One of the functions of the searcher in trying to locate multipath-propagated components is to search for the correct code phase by means of a matched filter. A received signal is input into the matched filter, whereafter the signal is sampled. The formed samples are correlated with predetermined data, which consists for example of pilot symbols multiplied by the user's spreading code. The radio system channel on which the length of the measuring window for the impulse response should be adapted to the existing conditions is not significant for the invention, but the adaptation can be carried out either collectively on all the radio channels or specifically on each channel. For example in a UMTS, the invention is typically utilized on dedicated physical channels (DPCH).

A basic idea of the arrangement according to the invention is that in a radio system receiver, such as a base station, the length of a measuring window to be used in a searcher is adapted to the existing conditions of signal reception. An impulse response formed from a user signal is used to compose a delay spread, which refers to the difference in time between two significant delay components that are remotest from one another. A delay spread can exhibit great variations depending on the surroundings. The invention utilizes information on variation in the delay spread in determining the length of the measuring window of the searcher. For example in urban conditions, where signal components are reflected from objects located close to one another, delay spreads are typically in the range of 2 ms. In such a case a sufficient measuring window for an impulse response has duration of for example 4 ms. In mountain conditions, a delay spread can be as long as 30 ms, which may require a measuring window of up to 40 ms.

In a preferred embodiment of the invention, a delay spread is measured from a user signal during connection set-up or as soon as possible after the connection has been set up. The delay spread is used to suitably adapt the length of the measuring window used to receive the user signal in question. A delay spread can be measured more than once during a connection, and correspondingly, the length of the measuring window can be allocated several times during a connection. In an embodiment, if the user signal is subjected to fading, a very long measuring window is temporarily allocated during the connection.

Another preferred embodiment comprises measuring an average delay spread of terminal equipments located in the coverage area of the radio system, and allocating a measuring window that is equal to or in practice slightly longer than the average delay spread to the terminal equipments arriving at the coverage area. It is clear that the measurement of an average can be replaced with some other statistical value to indicate the extent of the delay spreads. A radio system coverage area refers herein preferably to a base station cell, but the allocation can also be carried out at a more specific level, such as specifically for each sector.

In an embodiment of the invention, information measured from the delay spread or an estimate of the delay spread is used for receiver synchronization. This is implemented by searching the received spread spectrum signal for a first delay component, followed by searching for other delay components from both sides of the first located delay component for a period of time equal to a maximum delay spread. This ensures that all the signal energy is utilized in the reception of a user signal. The search is preferably a z search, where the signal components found according to the invention are placed centrally in the measuring window. In an embodiment, the outermost signal components located in the search and the edges of the measuring window are separated by a safety margin, which is intended to ensure that new components that may be located later on will fall within the measuring window.

An advantage of the invention is that in easy reception circumstances, when user signals have short delay spreads, the receiver requires fewer resources to implement a measuring window for an impulse response.

### BRIEF DESCRIPTION OF THE FIGURES

In the following, the invention will be described in more detail in connection with preferred embodiments and with reference to the accompanying drawings, in which

FIG. 1 shows an operating situation in a radio system where a receiver receives several multipath-propagated signal components,

FIG. 2 shows an impulse response of a user signal,

FIG. 3 shows a preferred embodiment of a method according to the invention,

FIG. 4 shows another preferred embodiment of the method according to the invention,

FIG. 5 shows allocating the length of a measuring window by means of measurement results of a delay spread,

FIG. 6 shows allocating the length of the measuring window by means of measurement results of the delay spread,

FIG. 7 shows determining the location of a measuring window by means of an impulse response,

FIG. 8 shows determining the location of the measuring window by means of the impulse response, and

FIG. 9 shows a preferred embodiment of a receiver according to the invention.

### DESCRIPTION OF THE EMBODIMENTS

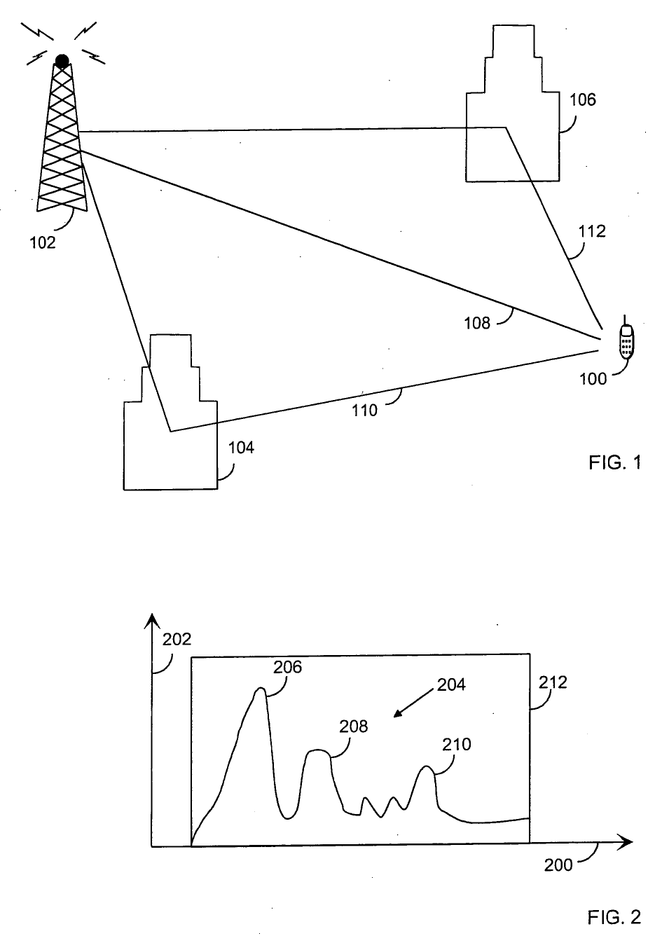

FIG. 1 shows an operating situation of a radio network. A coverage area of a base station 102 comprises a terminal equipment 100, which communicates over a bidirectional radio connection with the base station 102. The figure shows different paths of propagation of the signal transmitted from the terminal equipment to the base station 102. One signal component 108 illustrates a direct signal propagating from the terminal equipment to the base station, whereas signal components 110 and 112 are reflected from buildings 104 and 106. In a radio system realized by the spread spectrum technique, these multipath-propagated signal components 108 to 112 can be combined to better identify the transmitted signal in the receiver.

FIG. 2 shows an impulse response graph 204 of a user signal corresponding to the terminal equipment 100 and formed in the operating situation shown in FIG. 1. The x-axis 200 of FIG. 2 illustrates the time delay of the signal, i.e. the signal components that have propagated a longer distance over the radio path are shown in the figure on the right. The y-axis 202 in the figure represents the amplitude, or energy, of the signal component. The signal component 206 with the greatest energy and the shortest delay corresponds to the direct propagation path 108 of the radio signal shown in FIG. 1, and the two other significant signal components 208 and 210 correspond to the signal components 110 and 112 that reflected off the buildings. In the base station receiver, which is preferably a rake receiver, a rake finger is arranged to monitor each significant signal component 206 to 210 from the received signal. FIG. 2 also shows a measuring window 212 for an impulse response. Adjustment of the length of the measuring window will be described in more detail in connection with the other figures.

The arrangements according to the preferred embodiments are implemented in a spread spectrum radio system. An example of such systems is the 3G UMTS, which will be described below. The structure of the UMTS is mainly divided into system parts, i.e. the terminal equipment and the infrastructure. A terminal equipment refers herein for example to a mobile phone, a laptop computer or a domestic appliance arranged to be used via a telecommunications network. A terminal equipment can be further divided into two subdivisions, i.e. a mobile equipment (ME) and a user services identity module (USIM), the interface between them being called a Cu interface. A mobile equipment implements radio interface functions and also comprises a number of other functions, such as connecting the mobile equipment to a laptop computer. The USIM comprises data and functions for identifying a user in the radio system. The USIM also enables the user to change the terminal equipment he/she is using, similarly as a SIM card is changed in the GSM system. The infrastructure is in turn divided into an access network domain and a core network domain, the interface between the domains being referred to as an Iu interface. The access network domain, which is also referred to as a UMTS terrestrial radio access network (UTRAN), comprises physical equipment and mechanisms enabling the user to use the network, whereas the core network domain controls the network at a higher level, i.e. for example it manages user location information, data transmission and signalling. The core network domain comprises three subdivisions: a serving network, a home network and a transit network. The serving network is responsible for call routing and user data transmission between a data source and a target. The serving network is also connected to the home network and the transit network. The home network manages network functions based on permanent location. The transit network manages connections outside the UMTS network in cases where one party to a connection is located outside the UTMS network.

A Uu radio interface between the terminal equipment UE and the UTRAN is a three-level protocol stack consisting of a physical layer L1, a data link layer L2 and a network layer L3. The L2 is further divided into two sublayers, i.e. an LAC (Link Access Control) layer and an MAC (Medium Access Control) layer. The L3 and the LAC are further divided into control (C) and user (U) planes. The physical layer L1 provides the MAC and higher layers with information transfer services to transport channels. The L2/MAC in turn transmits information between the physical transport channels and logical channels that are located higher on the protocol stack. There are different types of logical channels in the UTMS and in other digital systems, e.g. control channels and traffic channels. Some of the radio channels are uplink channels, i.e. from the terminal equipment to the cellular system, whereas some are downlink channels, i.e. from the mobile phone system to the terminal equipment. A control channel is not used to allocate radio resources for a terminal equipment, but a control channel manages tasks related to the use of the system, such as paging of terminal equipments on a paging channel (PCH) that is shared by all the terminal equipments. An example of uplink control channels is a random access channel (RACH), which is used by a terminal equipment to transmit call set-up requests to the network. The radio resources allocated to a terminal equipment for actual traffic channels depend on the transmission need. An example of logical traffic channels is a dedicated channel (DCH), which carries information both in the downlink and the uplink direction. The UMTS also comprises several other channels, but they are not significant for the invention and will thus not be described herein.

Frame structures used on physical channels differ depending on the channel on which transmission occurs. A frame refers herein to a combination of several time slots, where the function of bits in each time slot is specified. An example of a frame is a frame of a DPCH physical channel in the FDD (Frequency Division Duplex) mode of UMTS. The frame length is 10 ms and the frame is divided into 15 time slots, the length of each slot being 0.667 ms. A time slot is used to transfer not only data bits and other information but also known pilot bits utilized in the rake receiver.

When a receiver, such as a terminal equipment or a radio network base station, receives frames on a channel, it forms a channel estimate and a channel impulse response by means of burse pilot bits. Formation of a channel estimate means that the receiver tries to estimate how the radio path has distorted the data contents of the burst. By means of the obtained information, the receiver may use known methods to try to restore the burst data contents according to the channel estimate. The rake receiver allocates the fingers by means of the pilot bits and the impulse response formed from the pilot bits. Channel quality can be estimated by means of the pilot bits and previously known methods, such as the signal-to-interference ratio (SIR) and the bit error rate (BER).

Information to be transmitted over a radio channel is multiplied by a spreading code in order to spread rather narrowband information to a wide frequency band. Each connection Uu has a specific channelization code(s) used by the receiver to identify transmissions intended for it. The maximum number of mutually orthogonal channelization codes that can be used simultaneously is typically 256 different codes. For example over the downlink transmission path in the UMTS, with a 5 MHz carrier of 3.84 Mch/s, spreading factor 256 corresponds to a transfer rate of 32 kbit/s, and the corresponding highest transfer rate in practice is achieved with spreading factor 4, which gives a data transfer rate of 1920 kbit/s. The transfer rate on a channel thus varies in steps of 30, 60, 120, 240, 480, 960 and 1920 kbit/s, and the spreading factor changes correspondingly as follows: 256, 128, 64, 32, 16, 8 and 4. The data transfer rate allocated to a user depends on the channel coding used. For example with 1/3 convolutional coding, the user data transfer rate is usually about one third of the channel data transfer rate. The spreading factor indicates the length of the spreading code. For example the channelization code corresponding to spreading factor 1 is (1). Spreading factor 2 has two mutually orthogonal channelization codes: (1,1) and (1,−1). Further, spreading factor 4 has four mutually orthogonal channelization codes: below a higher-level channelization code (1,1) are channelization codes (1,1,1,1) and (1,1,−1,−1), and below another higher-level channelization code (1,−1) are channelization codes (1,−1,1,−1) and (1,−1,−1,1). Formation of channelization codes proceeds in this manner to the lower levels of the code tree. Channelization codes of a particular level are always mutually orthogonal. Similarly, a channelization code of a particular level is orthogonal with all the channelization codes of subsequent levels derived from another channelization code of the same level. In transmission, one symbol is multiplied by a spreading code, i.e. a combination of a channelization code and a scrambling code, in order to spread the data to the frequency band used. For example in the case of channelization code 256, one symbol is represented by 256 chips. Correspondingly, with channelization code 16, one symbol is represented by 16 chips.

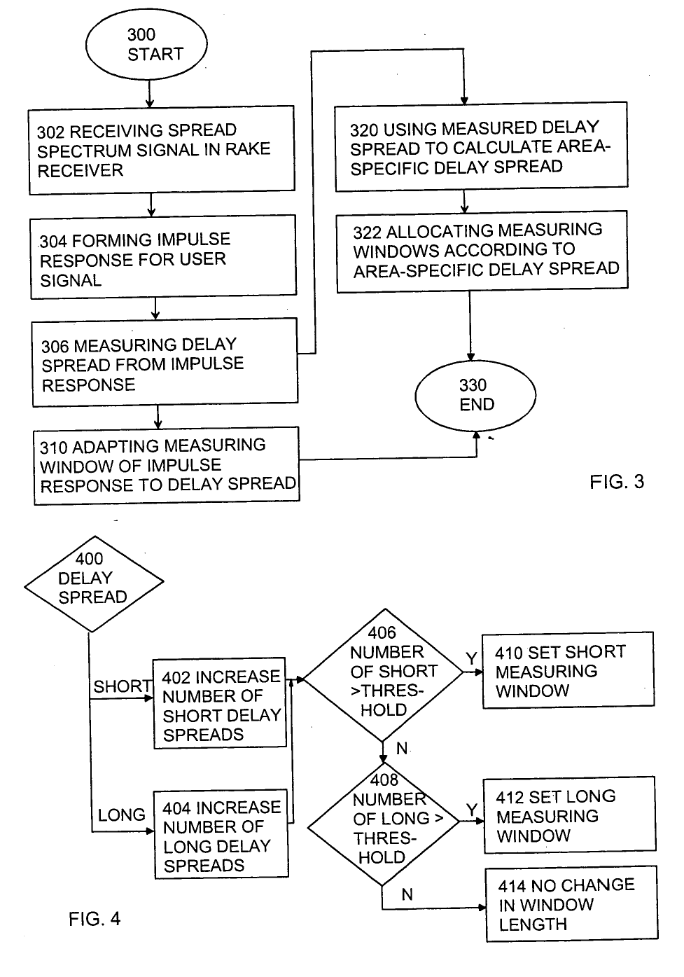

FIG. 3 illustrates a preferred embodiment of the method. In step 302, the receiver receives a spread spectrum signal typically containing several multipath-propagated components of signals of a plurality of users. Step 304 illustrates detection of a signal of a particular user in a rake receiver. An impulse response is formed in the receiver by correlating the received spread spectrum signal and a user signal sample. The user signal sample is formed by multiplying pilot symbols known to several terminal equipments by the user's spreading code. The user signal sample has a length of hundreds, even thousands of chips, depending on the channel noise level. Correlation is carried out in the rake receiver in the correlator, i.e. the matched filter, which can form one or m ore points of the user channel impulse response at a time.

Method step 306 comprises measuring, from the formed impulse response, a delay spread, which refers to the difference in time between the first and the last significant tap of the impulse response. The significance can be determined for example by means of signal energy or a threshold set for the signal-to-interference ratio. In urban environments, delay spreads are typically in the range of 1 to 2 ms, whereas in mountain areas a delay spread can be even longer than 20 ms. Chip duration at a chip rate of 3.84 Mcps is 0.26 ms, which means that a 1 ms delay spread requires a measuring window of about four chips, and a 20 ms delay spread requires a measuring window of almost 80 chips. In a rake receiver, measuring windows of different lengths can be realized in principle in two manners, i.e. either by allocating matched filters of different lengths or by controlling several measuring time slots by software from a time-multiplexed matched filter. For example a measuring window of 32 chips can be provided by using either one measuring time slot from a matched filter of 32 chips, or by using four measuring time slots from a matched filter of eight chips.

The method diagram of FIG. 3 illustrates two different embodiments, where step 310 forms the first embodiment and steps 320 to 322 form the second embodiment. In step 310 of the first embodiment, the measured delay spread is used to determine the amount of correlator resources for the user whose user signal was used to form the impulse response in step 304. For example, if the measured delay spread is 12 chips in length, the user is allocated for example 16 chips of correlation resources to be used over the connection in order to ensure that the delay spread fits in the measuring window. The impulse response is preferably measured in step 304 immediately at the beginning of the connection, and the resources to be allocated in step 310 are used in formation of an impulse response for the rest of the connection. Impulse responses are typically formed at intervals of 10 ms or more. It is clear that a measuring window can be adapted to a delay spread several times and not only once during a connection. If the allocation is carried out several times during a connection, a relatively long measuring window is preferably used in step 304 in order to take into account a possible increase in the delay spread. For example, if the first measurement of the delay spread provides a spread of 3 ms, the measuring window to be allocated is 4 ms in length. If a measurement carried out during the connection provides a delay spread of 6 ms, the measuring window is updated to 8 ms, for instance. With respect to equipment resources, the correlator used to form an impulse response in step 304 and the correlator to be allocated in step 310 represent the same physical correlator resource, but the correlator forming the first impulse response can naturally be different from the correlator used later in signal reception.

Method steps 320 to 322 describe an embodiment, where a delay spread measured from a user signal is used in a receiver to determine the length of a measuring window applied in a particular coverage area. A coverage area refers herein to a base station cell or sector, for example. Delay spreads measured in a particular base station site are rather close to one another in practice, wherefore a delay spread can be measured for a base station site or sector, to be used for terminal equipments communicating in the area. In step 320, a general delay spread is calculated for example by means of an average of delay spreads. An example is a situation where a 6 ms delay spread has been measured in the area of a base station cell. In such a case, a measuring window of e.g. 8 ms would be used invariably in the base station area. By means of the method described above, base stations can be rapidly adapted to new environments with different delay profiles. Generally, a new base station can be allocated for example a long measuring window, e.g. 30 ms in length, the window being possibly shortened according to information obtained from measurements of actual delay spreads.

FIG. 4 shows an embodiment of the method, where the operation of the receiver is illustrated in the case of two measuring windows of different lengths. A threshold length of for example 4 ms is set for a delay spread, and delay spreads that are shorter than the threshold are classified into short delay spreads and spreads longer than the threshold are classified into long spreads. When a majority of the delay spreads are short, the length of the measuring window is maintained at 16 chips, whereas if long delay spreads are in the majority, the length of the measuring window is increased to 32 chips. In step 400, a delay spread measured from a user signal is estimated. If the delay spread is short, the number of measurement results indicating short spreads is increased in step 402. Correspondingly, if the measured delay spread is long, the number of long delay spreads is increased in step 404. In step 406, it is estimated whether the percentage of the short delay spreads of all the measurement results exceeds the threshold value set for the length of the measuring window. If the threshold value is exceeded, a short measuring window is set in step 410. If the number of the short delay spreads does not exceed the threshold value, the percentage of the long delay spreads of the total number of delay spreads is checked in a condition node 408. If the number of the long delay spreads exceeds the threshold value, a long measuring window is set in step 412. If the threshold value is not exceeded, the length of the measuring window is not changed, as shown in step 414. A situation as described in FIG. 4 occurs for example when a new base station is being introduced.

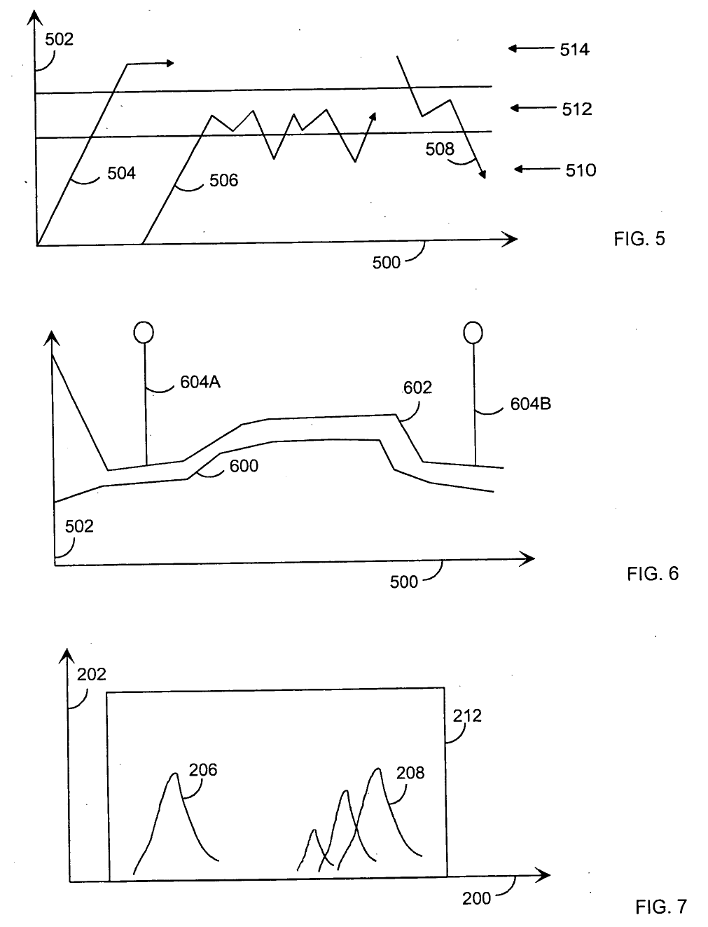

In FIG. 5, the x-axis 500 shows time and the y-axis 502 shows measurement results of a delay spread as a function of time for example in the area of a base station cell. Area 510 indicating long measurement results of a delay spread signifies a long measuring window, and area 514 signifies the area of a short measuring window. Between the area 510 of the long measuring window and the area 514 of the short measuring window there is an uncertainty area 512, where measurement results are not classified into either category, nor is there any transfer from one measuring mode to another in the uncertainty area 512. Graph 504 illustrates how a long measuring window is used initially, but the delay spread measurements rapidly indicate that a short window suffices. According to graph 506, a long measuring window is used at the beginning of the delay spread measurements, but the results of the measurements rapidly end up in the uncertainty area 512. However, since the measurement results do not exceed the threshold value for the short measurement area, a long measuring window is still allocated to new connections for impulse response measurements in the receiver. Graph 508 shows a situation where signal reception is initiated at the base station with short measuring windows. However, measurements of a preliminary delay profile or measurements on connection quality indicate that the measuring window used is too short and not all signal components are received. The length of the measuring window is thus lengthened in the receiver.

FIG. 6 illustrates determination of the length of a measuring window for an impulse response for example in the area of a base station cell. In FIG. 6, the measuring window for an impulse response is lengthened in moving upwards along the y-axis 502. Graph 600 illustrates a statistical value, such as a moving average, calculated from the delay spread measurements. Graph 602 in turn represents the length of the measuring window used in the receiver. The figure shows that between the average delay spread and the length of the measuring window there is a buffer zone used by the receiver to be prepared for changes in the delay spread concerning a large number of users. Measurements 604A and 604B illustrate individual delay spread measurements, where a terminal equipment is in a difficult fading situation, for instance. A very long measuring window is then allocated temporarily to the terminal equipment to ensure that all the signal components are obtained in order to facilitate the identification of the terminal equipment signal.

FIG. 7 illustrates preliminary placement of a measuring window in order to synchronize a receiver with a user signal. In certain situations, such as a soft or a softer handover, preliminary synchronization is obtained by means of a z search. The z search comprises searching for delay components of a user signal by directing a preliminary search at the delay area that mostly likely corresponds to the location of the terminal equipment which transmitted the signal. In FIG. 7, the user signal has been searched from left to right, and the first delay component 206 of the user signal has been found. The next step in checking the signal is searching for signal components from both sides of the signal for a period of time that is equal to a maximum delay spread. Another delay component group 208 in the user signal should also be located inside the measuring window 212 for the impulse response. Correspondingly, if the search is started from the right and the first signal component is located, it is checked whether the area to the right of the located component has been searched for a period of time equalling the maximum delay spread. If the duration of the search directed to the right corresponds to the duration of the maximum delay spread, it is sufficient to search for new signal components to the left of the first located signal component for a period of time equal to the maximum delay spread. If the search that started from the right was not continued to the right from the first located signal component for a period of time equal to the maximum delay spread, the search is extended both to the left and the right from the located component for a period of time equalling the maximum delay spread. The located signal components are placed centrally in the measuring window and the edges of the window are provided with safety margins.

The z search described above provides advantages over a conventional z search in several possible problem situations. In the conventional z search, when the first component is located in a search beginning for example from the left, the measuring window is placed with the located component on the very left edge of the window. The arrangement according to the preferred embodiment shown in FIG. 7 avoids problems resulting e.g. from a new delay component being found to the left of the first located delay component 206 after the entire area has been searched. The arrangement also avoids problems that occur if a search that started from the left began from the wrong place, i.e. a component that is to the left of the located component 206 would not fall within the measuring window. Yet another problem situation is that a delay component is located so far to the right of the located delay component 206 that the preliminary search was not able to locate it. Such problem situations can be avoided by the present arrangement, where both sides of the first located component are checked on the delay domain for a period of time corresponding substantially to the maximum delay spread. This arrangement improves the likelihood of the receiver locating all the signal components, wherefore most of the signal energy can be recovered.

A maximum delay spread is obtained for example by estimating the terrain surrounding the base station or by measuring the delay spread from one or more user signals. If the measured maximum delay spread is for example 20 ms in length, the measurement can be extended to both sides of the first located tap for a period of 25 ms, which means that the search includes a guard period of 5 ms. In an embodiment, if the first tap has been located in a search that began from the left and the search has already continued to the left for a period of time equal to the maximum delay spread, the search can be directed only to the right of the located tap.

In a preferred embodiment, when the z search has been finished, the located taps are placed in the receiver substantially in the middle of the measuring window, and safety margins are left between the located taps and the edges of the measuring window. The measuring window to be used is preferably for example 20 ms in length. If the distance in time between tap 206 and the last tap of group 208 is for example 10 ms, safety margins of 5 ms are left on both sides of the taps.

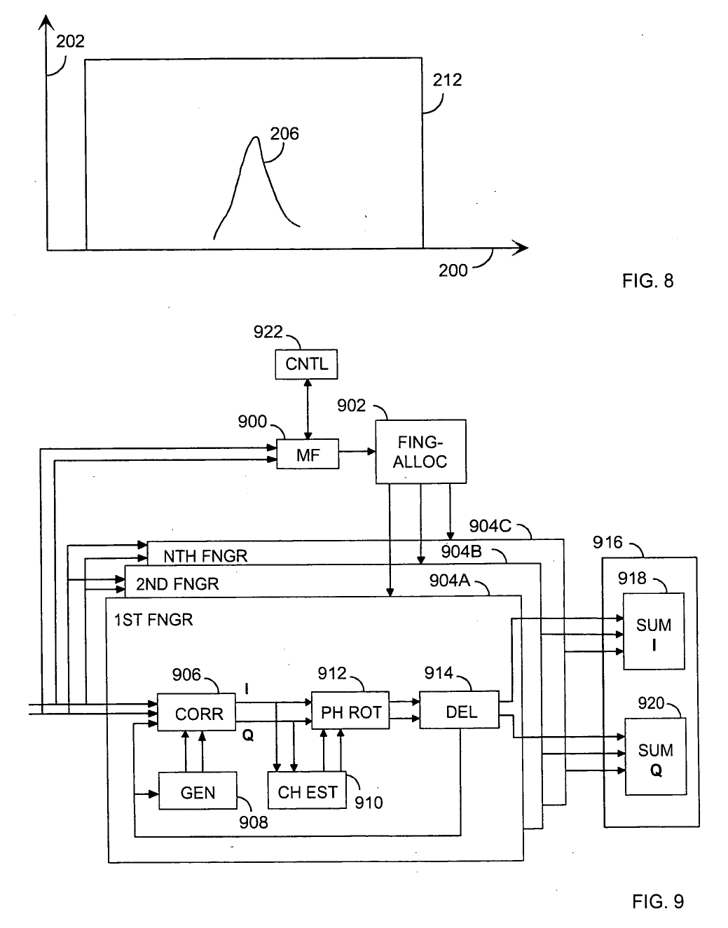

The situation shown in FIG. 8 illustrates preliminary measurement of a user signal, which has located only one tap, thus resulting in placement of the tap substantially in the middle of the measuring window. With a measuring window of 20 ms, the safety margins on both sides of the located tap are about 10 ms in length. Reception of a user signal can be initiated in the receiver immediately during the z search, after the first tap has been located in the search. It is thus not necessary to wait until all the taps have been located.

FIG. 9 illustrates an embodiment of components of a rake receiver that are essential for the invention. A conventional CDMA receiver usually comprises one to ten rake fingers, each of which monitors one multipath-propagated component of the received user signal. Due to the mobility of the mobile station, the propagation environment between the base station and the mobile station keeps changing and the strength and number of the multipath-propagated signals vary according to the mobile station location. A signal is received in the receiver by one or more antenna receivers and supplied after radio-frequency parts to an A/D converter, which provides signals modulated e.g. with QPSK such that I and Q branches of the signal are separated. The signal that was sampled in the A/D converter is supplied to a searcher, which locates the multipath-propagated components of the signal. An impulse response is measured by means of a matched filter 900 or a 1-chip searcher. When a connection is being set up, the matched filter 900 provided in the searcher tends to synchronize with the pilot bits spread by the spreading code in order to form an impulse response. The received signal is filtered in the searcher by a relatively long matched filter 900 in order to locate the correct phase of the spreading code as quickly as possible. After the matched filter 900 of the searcher has synchronized with the correct phase of the spreading code, it can be shortened for example to 32 chips for the purpose of traffic channel reception, for example. The searcher also comprises allocating means 902, which determine the delays of the different signal components from the impulse response formed in the matched filter 900, and which allocate the components to fingers 904A to 904C of the rake receiver for monitoring. The allocating means 902 identify the strongest multipath-propagated components from the channel impulse response and reallocate the fingers 904A to 904C if multipath-propagated components that are stronger than the old components have been found from the channel impulse response. The fingers 904A to 904C can also be reallocated at regular intervals. Each finger 904A-904C comprises a correlator 906 and a code generator 908 for composing one multipath-propagated component of the user signal. A channel estimator 910 utilizes pilot symbols to estimate the channel phase. A phase rotator 912 can remove the effect of the channel from the received symbols. The signal delay is corrected by means of a delay unit 914, so that the signals received by different rake fingers can be phased with one another. A combiner 916 of the rake receiver combines the signals received by the different rake fingers 904A to 904C in order to obtain multipath diversity against channel fading. The I and Q branches are combined in separate adders 918 and 920. In a typical rake receiver, chip-level processing, such as correlators, code generators and matched filters, is realized by means of ASICs (Application Specific Integrated Circuit), whereas symbol-level processing, such as channel estimation, phase rotation and combining, is implemented by means of DSP (Digital Signal Processing). A rake receiver also comprises a control unit 922 comprising means for measuring a delay spread of an impulse response, and means for determining the length of a measuring window for an impulse response according to the delay spread. If required, the control unit also increases the length of the measuring window by software. For example, if the physical implementation of the matched filters is 4 chips, a user signal can be received with 8 chips by measuring the signal in two time slots of the matched filter. If required, the means determining the length of the measuring window for the impulse response also form statistics about the average delay spread of terminal equipments located in a particular coverage area, the means allocating measuring windows of a required length for an impulse response to the coverage area. The control unit preferably also implements the means required for a z search, i.e. means of locating the first delay component from the received signal, the locating means being also configured to search for other delay components from both sides of the first component for a period of time that is equal to the maximum delay spread. The functionality of the control unit and the means thereof is realized e.g. by software, ASICs or logical components.

Even though the invention is described above with reference to an example according to the accompanying drawings, it is evident that the invention is not restricted thereto but it can be modified in several manners within the scope of the inventive idea disclosed in the appended claims.

1. A method of receiving a spread spectrum signal in a radio system receiver, the method comprising:
receiving, in a receiver, a spread spectrum signal comprising one or more user signals;
forming an impulse response representing delay components of a user signal on the time domain;
measuring, from the formed impulse response, a delay spread of the delay components that are significant for the reception of the user signal, and
determining, in the receiver, lengths of measuring windows for impulse responses related to one or more user signals by means of the measured delay spread.

2. A method of preliminary synchronization of a user signal contained in a spread spectrum signal in a radio system receiver, the method comprising:
receiving a spread spectrum signal comprising one or more user signals in the receiver;
searching the user signal on the delay domain for a first delay component, and
searching for delay components of the user signal from both sides of the first located delay component on the delay domain, so that the user signal is searched from both sides of the located signal component for a period of time equal to a maximum delay spread of the impulse response in the operating range of the receiver.

3. A method according to claim 1, wherein
an impulse response representing the delay components of the first user signal on the time domain is formed from the spread spectrum signal;
a delay spread of the delay components that are significant for the reception of the first user signal is measured from the formed impulse response, and
the length of a measuring window for the impulse response of the first user signal is determined in the receiver by means of the measured delay spread of the first user signal.

4. A method according to claim 1, wherein:
an impulse response representing the delay components of the first user signal on the time domain is formed from the spread spectrum signal,
a delay spread of the delay components that are significant for the reception of the first user signal is measured from the formed impulse response, and
the length of a measuring window for an impulse response to be formed in connection with the reception of at least one other user signal is determined in the receiver by means of the measured delay spread of the first user signal.

5. A method according to claim 1, wherein
in the radio system, delay spread information that is specific for the coverage area of the radio system is formed by means of delay spreads measured from one or more user signals, and
the lengths of measuring windows for the impulse responses of the user signals to be received from said coverage area are determined by means of the formed coverage-area-specific delay spread information.

6. A method according to claim 1, further comprising:
using at least two different lengths for the measuring window for the impulse response in the receiver,
starting the reception of user signals in the receiver with the first length of the measuring window for the impulse response, the second length of the measuring window, which is shorter than the first length, enabling the reception of a user signal in the receiver,
measuring delay spreads of several user signals in the receiver,
introducing the second length of the measuring window, which is shorter than the first measuring window, into the reception of user signals if a proportion of the measured delay spread lengths equal to a predetermined threshold fit in a period of time equal corresponding to the second length of the measuring window.

7. A method according to claim 1, further comprising:
measuring the delay spread repeatedly during the reception of the user signal, and
changing the length of the measuring window according to changes in the delay spread, if required.

8. A method according to claim 1, further comprising:
increasing the length of the measuring window temporarily if fading is detected in the user signal.

9. A method according to claim 2, further comprising:
starting signal reception after the first delay component of the received signal has been located.

10. A method according to claim 2, further comprising:
placing one or more located delay components centrally in the measuring window for the impulse response, and
providing safety margins between the outermost delay components and the edges of the measuring window to ensure that any new delay components that are located during the further search through the user signal fall within the measuring window for the impulse response.

11. A method according to claim 2, further comprising:
checking the user signal from the first side until a first signal component is located,
searching for delay components of the user signal from the other side of the first signal component for a period of time that is equal to the maximum delay spread, and
searching for delay components of the user signal from the first side of the first signal component for a period of time that is equal to the maximum delay spread, if the signal has not been checked from said first side for a period of time equal to the maximum delay spread.

12. A method according to claim 2, wherein the search method in preliminary synchronization is a z search.

13. A rake receiver, comprising:
means for receiving a spread spectrum signal in a radio system;
means for forming an impulse response representing, on the time domain, delay components of a user signal contained in the spread spectrum signal;
means for measuring, from the formed impulse response, a delay spread of delay components that are significant for the reception of the user signal, and
means for determining the length of the measuring window for the impulse response by means of the measured delay spread of the user signal.

14. A rake receiver, comprising:
means for receiving a spread spectrum signal containing one or more user signals;
means for locating the first delay component from the user signal, wherein
the locating means are configured to search for other delay components of the user signal from both sides of the first located delay components on the delay domain by searching the user signal from both sides for a period of time equal to a maximum delay spread of the impulse response of the user signal in the operating range of the receiver.

15. A rake receiver according to claim 13, wherein
the forming means are configured to form, from the spread spectrum signal, an impulse response representing the delay components of the first user signal on the time domain,
the measuring means are configured to measure, from the formed impulse response, the delay spread of the delay components that are significant for the reception of the first user signal, and
the determining means are configured to determine the length of the measuring window for the impulse response of the first user signal in the receiver by means of the measured delay spread of the first user signal.

16. A rake receiver according to claim 13, wherein
the forming means are configured to form, from the spread spectrum signal, an impulse response representing, on the time domain, the delay components of the first user signal;
the measuring means are configured to measure, from the formed impulse response, a delay spread of delay components that are significant for the reception of the first user signal; and
the determining means are configured to determine, in the receiver, the length of a measuring window for an impulse response to be formed in connection with the reception of at least one other user signal by means of the measured delay spread of the first user signal.

17. A rake receiver according to claim 13, wherein
the determining means are configured to form delay spread information specific to the coverage area of the radio system by means of delay spreads measured from one or more user signals, and to determine the lengths of measuring windows for the impulse responses of the user signals to be received from said coverage area by means of the formed coverage-area-specific delay spread information.

18. A rake receiver according to claim 13, wherein
the determining means are configured to use at least two different lengths for the measuring window for the impulse response in the reception,
the receiving means are configured to start reception of user signals with the first length of the measuring window, the second length of the measuring window, which is shorter than the first length, enabling the reception of a user signal in the receiver,
the measuring means are configured to measure the delay spreads of several user signals,
the determining means are configured to determine the second measuring window, which is shorter than the first measuring window, for use in the reception of user signals if a proportion of the measured delay spread lengths equal to a predetermined threshold fit in a period of time equal to the second length of the measuring window.

19. A rake receiver according to claim 13, wherein the measuring means are configured to measure the delay spread repeatedly during the reception of the user signal, and
the determining means are configured to change the length of the measuring window according to changes in the delay spread, if required.

20. A rake receiver according to claim 13, wherein the determining means are configured to increase the length of the measuring window temporarily if fading is detected in the user signal.

21. A rake receiver according to claim 14, wherein the receiver is configured to start signal reception after the first delay component has been located.

22. A rake receiver according to claim 14, wherein the locating means are configured to place one or more located delay components centrally in the measuring window for the impulse response, and to provide safety margins between the outermost delay components and the edges of the measuring window to ensure that any new delay components that are located during the further search through the user signal fall within the measuring window for the impulse response.

23. A rake receiver according to claim 14, wherein the locating means are configured to:
check the user signal from the first side until a first signal component is located;
search for delay components of the user signal from the other side of the first signal component for a period of time equal to a maximum delay spread, and
search for delay components of the user signal from the first side of the first signal component for a period of time equal to the maximum delay spread, if the signal has not been checked from said first side for a period of time equal to the maximum delay spread.

24. A rake receiver according to claim 13, wherein the locating means are configured to locate delay components in connection with a z search.
